(19) United States
(12) Patent Application Publication
(10) Pub. No.: US 2019/0321827 A1
(43) Pub. Date: Oct. 24, 2019

(54) A METHOD FOR PROVIDING AN AXIAL GAP IN A CUTTER ASSEMBLY OF A GRINDER PUMP, AND A GRINDER PUMP COMPRISING A SHIM CONFIGURED FOR PROVIDING SAID AXIAL GAP

(71) Applicant: Xylem Europe GmbH, Schaffhausen (CH)

(72) Inventor: Jan Bäcke, Svartsjö (SE)

(73) Assignee: Xylem Europe GmbH, Schaffhausen (CH)

(21) Appl. No.: 16/342,238

(22) PCT Filed: Oct. 16, 2017
(86) PCT No.: PCT/EP2017/076267

§ 371 Date: Apr. 16, 2019

(30) Foreign Application Priority Data
Oct. 17, 2016 (EP) 16194137.2

(51) Int. Cl. B02C 18/00; B02C 18/18

(52) U.S. Cl. CPC B02C 18/0092; F04D 29/20; B02C 18/18

(57) ABSTRACT

A method for providing an axial gap in a cutter assembly of a grinder pump in order to secure an operative shearing action at a shearing interface in the cutter assembly. A grinder pump includes a cutter wheel connected to and driven in rotation by a drive shaft. The cutter wheel includes a set of cutting edges, and a cutter disc stationary connected to a pump housing and having a central hole and a set of cutting holes. The drive shaft and the cutter wheel are interconnected via the central hole of the cutter disc, wherein the cutter wheel and the cutter disc constitute the cutter assembly. A shim, which has a thickness equal to or greater than 0.05 millimeters and equal to or less than 0.15 millimeters and that is manufactured from degradable paper or plastic material, is clamped between the cutter wheel and the cutter disc.

### TECHNICAL FIELD OF THE INVENTION

The present invention relates generally to the field of pumps configured for pumping liquid comprising solid matter. Further, the present invention relates to the field of grinder pumps for pumping slurries such as wastewater. More specifically the present invention relates to a method for providing an axial gap in a cutter assembly of such a grinder pump in order to secure an operative shearing action at a shearing interface in said cutter assembly. The cutter assembly comprises a cutter wheel and a cutter disc, wherein the shearing interface is located between said cutter wheel and said cutter disc. According to the inventive concept a shim is used in the grinder pump to provide an axial gap in the cutter assembly in order to secure the operative shearing action at the shearing interface in said cutter assembly of the grinder pump. Thus, the shim and the grinder pump are interrelated products having the same inventive concept and they need to work together in order to provide the result to be achieved.

The cutter wheel of the grinder pump is connected to and driven in rotation by an axially extending drive shaft of the grinder pump, the cutter wheel comprising a set of cutting edges, and the cutter disc is stationary connected to a pump housing of the grinder pump and has a central hole and a set of cutting holes, wherein the drive shaft and the cutter wheel are interconnected via said central hole of the cutter disc. The cutter assembly is configured for operative shearing action between the set of cutting edges of the cutter wheel and the set of cutting holes of the cutter disc at the shearing interface between the cutter wheel and the cutter disc.

### BACKGROUND OF THE INVENTION

Pumps which are adapted for pumping/transporting liquids and slurries containing solid matter may be equipped with means arranged on the suction side of the pump for cutting the solid matter which is suspended in the liquid into smaller fractions that are better sized to pass through the pump. These pumps are also referred to as grinder pumps or chopping pumps, many of which are structured as centrifugal pumps providing an axial intake flow of liquid, whereas the discharge flow is radial as seen with respect to the orientation of the pump. This type of pumps is commonly used in so-called Pressurized Sewage Systems (PSS), wherein each household comprises a small pump station and the wastewater from each pump station is pumped into a main pipe line and towards a larger pump station.

Grinder pumps are known from the literature. For example, applicants own U.S. Pat. No. 8,366,384 that disclose a grinder pump having a cutter wheel mounted in coaxial and co-rotating relation with an impeller of the pump. The main shearing/cutting action is provided from mutual interaction between radially extending main cutting edges of the cutter wheel and cutting holes of the cutter disc. Any solid matter of some length that is sucked into the cutting holes of the cutter disc is cut by the cutting edged of the cutter wheel in relative rotation to the cutter disc. The shearing capacity is crucially depending on an accurate axial clearance/gap between interacting cutting edges on the downstream end face of the cutter wheel and cutting holes at the upstream face of the cutter disc.

Many grinder pumps suffer from solid matter, such as long fibres, hair, plastics, etc. accumulating at and clogging the interface between a central hole of the cutter disc and a shaft portion of the cutter wheel, especially if the axial gap between the cutter wheel and the cutter disc is too big. Clogging results in excessive wear of the cutter disc and also decreased performance of the pump due to the increased friction. If the problem of clogging between the shaft portion of the cutter wheel and the central hole of the cutter disc is not addressed the solid matter will continue to accumulate about the entire cutter wheel and finally the entire cutter assembly and pump inlet is blocked.

In U.S. Pat. No. 8,366,384 the cutter wheel has an internal thread engaging an external thread on the drive shaft, thereto the pump comprises an adjustment screw, which alone is arranged to establish an axial clearance/gap at the shearing interface between the cutter wheel and the cutter plate by applying a separating axial force on the cutter wheel and on the drive shaft and thereby eliminating an axial play in the threaded engagement between the cutter wheel and the drive shaft. A drawback is that the axial play in said threaded engagement is not enough to obtain/secure the correct operational shearing action at the axial gap between the cutter wheel and the cutter disc. Thus, the cutter wheel has to be positioned a small distance from the cutter disc upon application of the adjustment screw and if the cutter wheel is not perfectly horizontal/parallel with the cutter disc the axial gap between at least one of the cutting edges of the cutter wheel and the cutter disc will be outside a predetermined/accepted range.

Obviously the mounting and adjustment procedure is time-wasting, and the known method is entirely relying on an operator's skill to ensure a reproducible clearance at all times. But since the ability to cut down solid matter that would otherwise block the liquid intake is crucial to the operation of the grinder pump, the accurate axial clearance has always to be ensured. It is thus a technical problem to improve the prior art pump such that an operative axial clearance/gap between cutter wheel and cutter disc is always reproduced upon mounting, and by which the risk of non-proper mounting is eliminated.

### OBJECT OF THE INVENTION

The present invention aims at obviating the aforementioned disadvantages and failings of previously known grinder pumps and methods for providing an axial gap in a cutter assembly of a grinder pump in order to secure an operative shearing action at a shearing interface in said cutter assembly, and at providing an improved grinder pump and an improved mounting method. A primary object of the present invention is to improve the prior art grinder pump and method such that an operative and reproducible axial clearance/gap between cutting elements is at all times ensured upon assembly. It is another object of the present invention to provide a grinder pump that is designed for ease of mounting, and by which the risk of non-proper mounting due to the skill/precision of the operator mounting the pump is eliminated.

### Further Elucidation of Prior Art

Document U.S. Pat. No. 5,209,636 disclose a pump or compressor wherein the axial clearance between the pump housing and a pump rotor is set by affixing several discrete spacers by means of adhesive between the end face of the rotor blades and an end plate of the pump housing.

### SUMMARY OF THE INVENTION

According to the invention at least the primary object is attained by means of the initially defined grinder pump and method having the features defined in the independent claims. Preferred embodiments of the present invention are further defined in the dependent claims.

According to a first aspect of the present invention, there is provided a grinder pump of the initially defined type, which is characterized in that a shim is clamped between the cutter wheel and the cutter disc, wherein the thickness of the shim is equal to or greater than 0.05 millimeters and equal to or less than 0.15 millimeters, and wherein the shim is manufactured from degradable paper or plastic material, wherein the grinder pump further comprises a locking member acting against the cutter wheel and the drive shaft and fixating the axial gap between the cutter wheel and the cutter disc provided by said shim, wherein the set of cutting holes of the cutter disc are located radially outside an imaginary circle that is concentric with an axial center axis of the grinder pump and that has a fourth diameter, an outer diameter of the shim being lesser than said fourth diameter of the imaginary circle of the cutter disc. According to a second aspect of the present invention, there is provided a method for providing the axial gap in a cutter assembly of a grinder pump according to the first aspect, wherein the method comprises the steps of connecting the cutter disc stationary to the pump housing of the grinder pump, placing the shim at the shearing interface between the cutter wheel and the cutter disc, connecting the cutter wheel to the drive shaft via the central hole of the cutter disc whereby said shim is clamped between the cutter wheel and the cutter disc, and applying the locking member to act against the cutter wheel and the drive shaft and thereby fixating the axial gap between the cutter wheel and the cutter disc provided by said shim.

Thus, the present invention is based on the insight of having a shim of predetermined thickness located at the specific shearing interface will guarantee that the axial gap between the respective cutting edge of the cutter wheel and the cutter disc is reproducible at all times, at the same time as the axial gap is kept fixated even after the shim has become degraded/removed during operation of the grinder pump.

In a preferred embodiment of the inventive grinder pump, the tensile strength of the plastic material of the shim is equal to or greater than 10 Newton/millimeter² and equal to or less than 50 Newton/millimeter². Thereto, it is preferred that the hardness of the plastic material of the shim is equal to or greater than 50 Shore D and equal to or less than 70 Shore D. Thus, the shim shall have the material characteristics to be able to withstand and last during the mounting and testing of the grinder pump, but at the same time become degraded/removed when the grinder pump is taken into proper operation.

In a preferred embodiment of the present invention, the shim has an annular basic shape. Thereby, the shim can be placed and kept in place about the drive shaft on the upside-down grinder pump before the cutter wheel is attached and fixated. According to a preferred embodiment of the inventive grinder pump, the cutter wheel comprises, a shaft portion that has a first diameter taken perpendicular to an axial center axis of the grinder pump and that is configured to interact with the central hole of said cutter disc, and a hub portion that is connected to the shaft portion and that has a second diameter, the second diameter being bigger than said first diameter, wherein the set of cutting edges extends in the radial direction outwards from said hub portion. Thereto, the inner diameter of the shim is greater than said first diameter of the shaft portion of the cutter wheel and lesser than said second diameter of the hub portion of the cutter wheel.

Thereby, the shim will not obstruct the flow of liquid through the cutting holes of the cutter disc before the shim has become degraded/removed.

Further advantages with and features of the invention will be apparent from the other dependent claims as well as from the following detailed description of preferred embodiments.

### BRIEF DESCRIPTION OF THE DRAWINGS

A more complete understanding of the abovementioned and other features and advantages of the present invention will be apparent from the following detailed description of preferred embodiments in conjunction with the appended drawings, wherein:

FIG. 1 is a schematic perspective exploded view from above of a portion of a grinder pump disclosing the relevant components of the invention,

FIG. 2 is a schematic cross sectional exploded side view of a portion of a grinder pump corresponding to FIG. 1,

FIG. 3 is a schematic cross sectional side view disclosing the grinder pump components of FIG. 2 in an assembled state,

FIG. 4 is a schematic side view from above of a cutter wheel of the grinder pump,

FIG. 5 is a schematic side view from below of an inventive shim,

FIG. 6 is a schematic side view from below of a cutter disc of the grinder pump,

FIG. 7 is a schematic perspective view from below of the pump inlet during assembly, wherein the cutter disc has just been connected to the pump housing,

FIG. 8 is a schematic perspective view from below of the pump inlet during assembly corresponding to FIG. 7, wherein the shim has just been added, and

FIG. 9 is a schematic perspective view from below of the pump inlet during assembly corresponding to FIGS. 7 and 8, wherein the cutter wheel is connected to the drive shaft and the locking member is attached to the cutter wheel.

### DETAILED DESCRIPTION OF PREFERRED EMBODIMENTS OF THE INVENTION

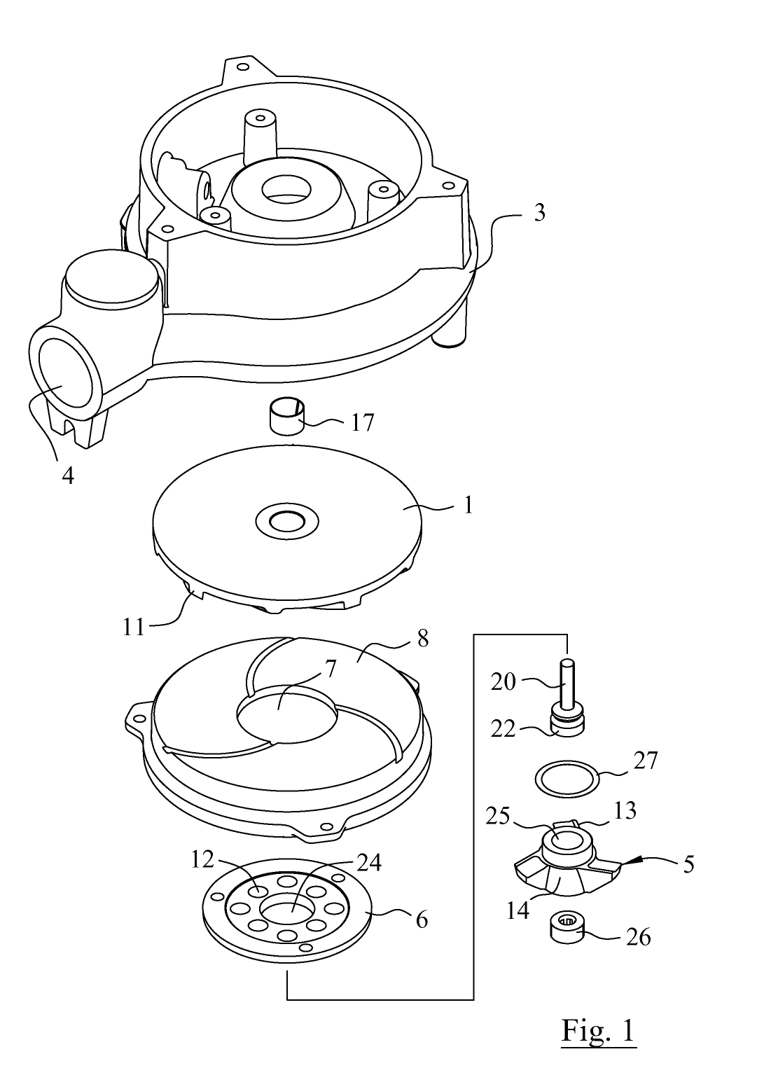

The present invention relates specifically to grinder pumps configured for pumping wastewater comprising solid matter. Reference is initially made to FIGS. 1-3.

A grinder pump, also known as chopping pump, comprises an impeller 1 which is journalled and driven for rotation in a pump chamber 2 defined by a pump housing 3. The pump housing 3 has an axial intake on the suction/upstream side of the pump and a radial discharge 4 on the pressure/downstream side of the pump for liquid transport effectuated by the impeller 1 in rotation during operation. Arranged co-axially with the impeller 1, and co-rotating therewith, the pump comprises a cutter wheel, generally designated 5. In operation, the cutter wheel 5 rotates on the upstream side of a cutter disc, generally designated 6, which is stationary connectable to the pump housing 3. More precisely, the cutter disc 6 is assembled in covering relation with a central intake opening 7 that is formed through a suction plate 8 that is stationary connectable to the pump housing 3 by means of bolts 9. The cutter disc 6 is mounted to the suction plate 8 by means of bolts 10. It shall be pointed out that the suction plate 8 is part of the pump housing 3 when it is in the mounted state.

It shall be pointed out that grinder pumps comprise a cutter assembly made up of the cutter wheel 5 and the cutter disc 6. The cutter wheel 5 and the cutter disc 6 are interrelated products that work together in order to provide the result of cutting the solid matter suspended in the liquid into smaller pieces.

In operation, as the impeller 1 rotates, liquid is sucked in through the intake opening 7 and discharged through the radial discharge 4 by centrifugal forces generated from at least one vane 11 formed on the impeller 1. The operation, which is well known, is that of a typical centrifugal pump and needs no further explanation herein. Thereto, the cutter disc 6 comprises a set of perforations/cutting holes 12 extending in the axial direction of the pump through the cutter disc 6 and providing passages through which the liquid and moderate sized solid matter suspended in the liquid may pass into the pump chamber 2.

The cutter wheel 5 comprises at least two main cutting edges 13 that are configured to interact with the set of cutting holes 12 of the cutter disc 6. The main cutting edges 13 of the cutter wheel 5 extend substantially in the radial directions of the pump from a central hub portion 14 of the cutter wheel 5. Each main cutting edge 13 is formed on the downstream side of a wing 15 that is connected to the hub portion 14, i.e. facing the cutter disc 6, and co-operate in a shearing interaction with the edges of the cutting holes 12 as the cutter wheel 5 is driven in rotation with respect to the cutter disc 6. Any solid matter of some length that is sucked in through the cutting holes 12 is cut by the cutter wheel 5 in relative rotation to the cutter disc 6.

The rotating components, i.e. the impeller 1 and the cutter wheel 5, are suspended at a lower end of a drive shaft 16 which is journaled in the pump housing 3 and is driven for rotation by means of an electric motor. Thus, the impeller 1 and the cutting wheel 5 are co-rotating and both driven for rotation by a common drive shaft 16.

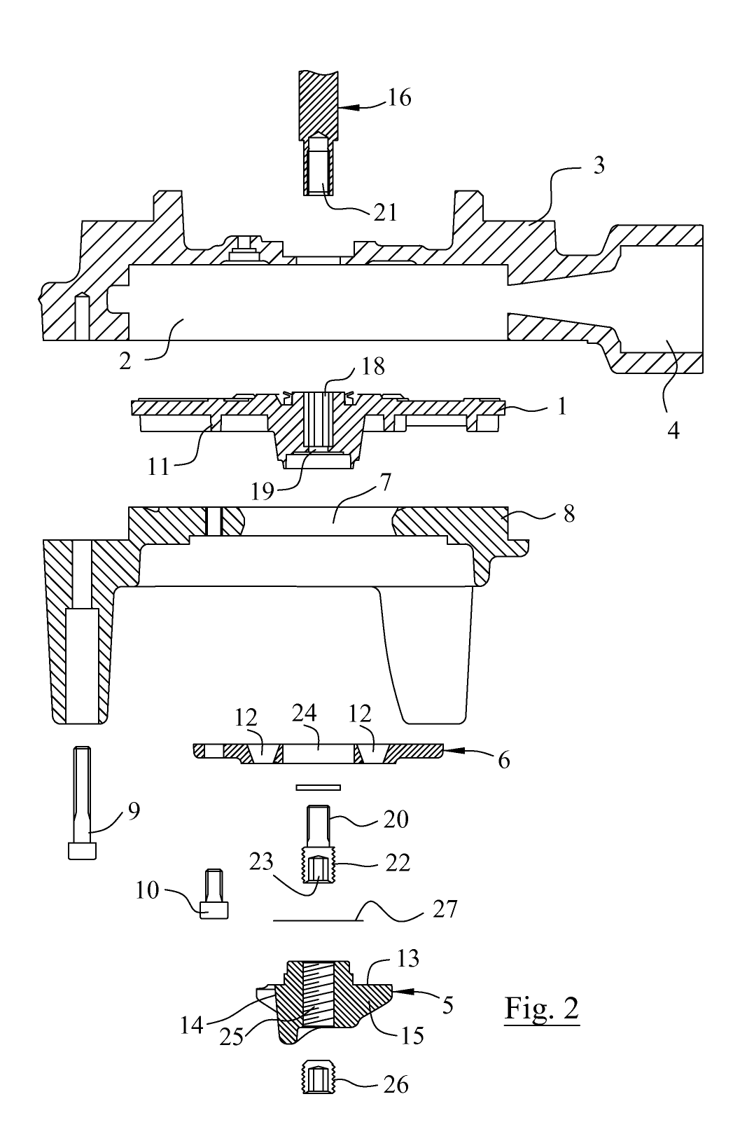

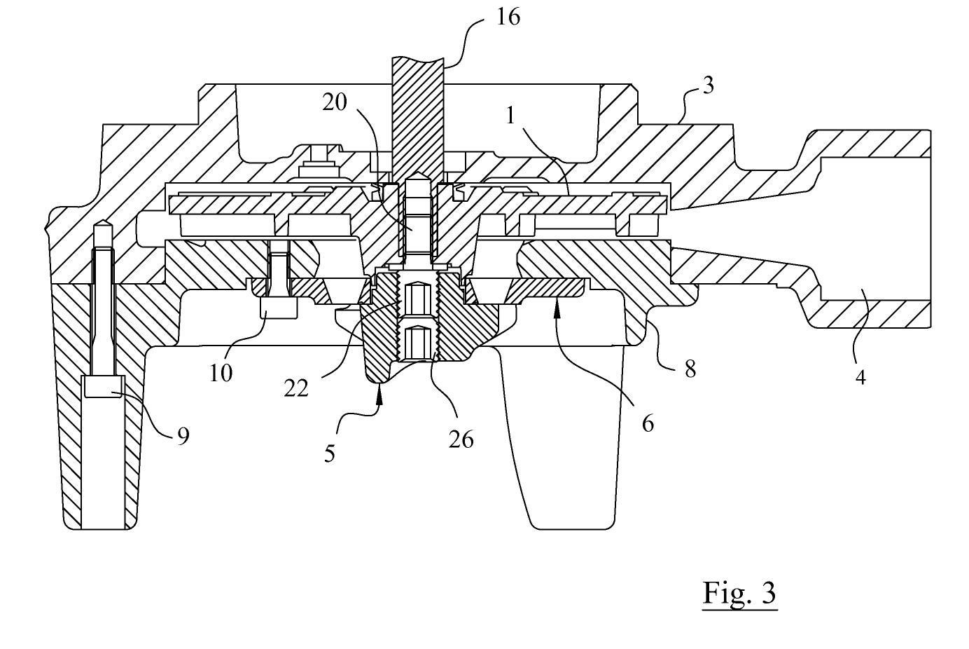

In the embodiment disclosed in FIG. 1, the pump comprises a conventional clamping sleeve 17 having a conical internal surface configured to engage a lower end of the drive shaft 16, wherein the lower end of the drive shaft has the shape of a truncated cone. The clamping sleeve 17 is configured to be pressed onto the drive shaft 16 and thereby expend in order to become wedged between the drive shaft 16 and the impeller 1. In the alternative embodiment disclosed in FIGS. 2 and 3, the lower end of the drive shaft 16 is provided with externally with splines, or the like. The impeller 1 has a central bore 18 with internal splines, or the like, to receive the lower end of the drive shaft 16 in a splined connection, i.e. a mutually non-rotational connection. The shaft end is preferably fully inserted in the bore 18 when the end face of the drive shaft 16 abuts a bottom of the bore 18. A hole 19 of lesser diameter through the bottom of the bore 18 admits the insertion of a central bolt 20 having an external thread for engagement with internal threads of a bore 21 which opens in the lower end of the drive shaft 16. It shall be pointed out that in the embodiment disclosed in FIG. 1 said central bolt 20 is configured to press the clamping sleeve 17 onto the lower end of the drive shaft 16 by engaging said bore 21 which opens in the lower end of the drive shaft 16. Thus, when fully inserted, the central bolt 20 secures the impeller 1 axially on the drive shaft 16.

The central bolt 20 is formed with a head 22 having an external thread, and is further provided with a seat 23 for engagement with a tool such as an Allen key, by which the central bolt 20 may be screwed into the bore 21 of the drive shaft 16. In inserted position the bolt head 22 effectively forms a threaded extension of the drive shaft 16, and the bolt head 22 is located in a central hole 24 of the cutter disc 6. According to an alternative embodiment the bolt head 22 is a permanent axial extension of the drive shaft 16. In such embodiment, the impeller is axially securable on the drive shaft by means of, e.g., a nut in threaded engagement with a thread that is formed externally on the axial extension of the drive shaft, onto which also the cutter wheel is mountable in threaded engagement. Thus, the central bolt 20 shall be considered as a part of or an extension of the drive shaft 16.

The cutter wheel 5 has a central through hole 25 having an internal thread by means of which the cutter wheel can be screwed onto the bolt head 22 in a threaded engagement. A stop screw 26 or adjusting element, which in the preferred embodiment is provided with an external thread, is insertable from the opposite end of the central through hole 25 in threaded engagement with the cutter wheel 5. The stop screw 26 is provided with a seat for engagement with a tool such as an Allen key, by which the stop screw 26 may be screwed into the central through hole 25 of the cutter wheel 5.

Essential for the present invention is that the grinder pump comprises a shim 27. The shim 27 is configured to provide an axial gap in a cutter assembly in order to secure an operative shearing action at the shearing interface of said cutter assembly. Thus, the shim 27 is configured to be clamped at the shearing interface between the cutter wheel 5 and the cutter disc 6 during mounting of the cutter assembly. According to the invention the thickness of the shim 27 is equal to or greater than 0.05 millimeters and equal to or less than 0.15 millimeters. Preferably the shim 27 is equal to or greater than 0.08 millimeters and preferably the shim 27 is equal to or less than 0.12 millimeters. In the disclosed embodiments the thickness of the shim 27 is equal to 0.10 millimeters. According to the invention the shim 27 is manufactured from degradable paper or plastic material, preferably biodegradable paper or plastic material. In the disclosed embodiments the shim 27 is manufactured from Polyethylene Terephthalate (PET). According to the disclosed embodiments the shim 27 has an annular basic shape, however other basic shapes are conceivable, such as squared, hexagonal, oval, etc.

It is vital that the shim 27 is not compressed during the mounting of the grinder pump and it is preferred that the shim 27 will survive/last a test run of the pump before the shim 27 is removed/degraded.

Preferably the plastic shim 27 presents the following material characteristics. The tensile strength of the plastic material of the shim 27 is equal to or greater than 10 Newton/millimeter² and equal to or less than 50 Newton/millimeter². The density of the plastic material of the shim 27 is equal to or greater than 0.8 gram/centimeter³ and equal to or less than 1.7 gram/centimeter³. The melt temperature of the plastic material of the shim 27 is equal to or greater than 120 degrees Celsius and equal to or less than 170 degrees Celsius. The hardness of the plastic material of the shim 27 is equal to or greater than 50 Shore D and equal to or less than 70 Shore D.

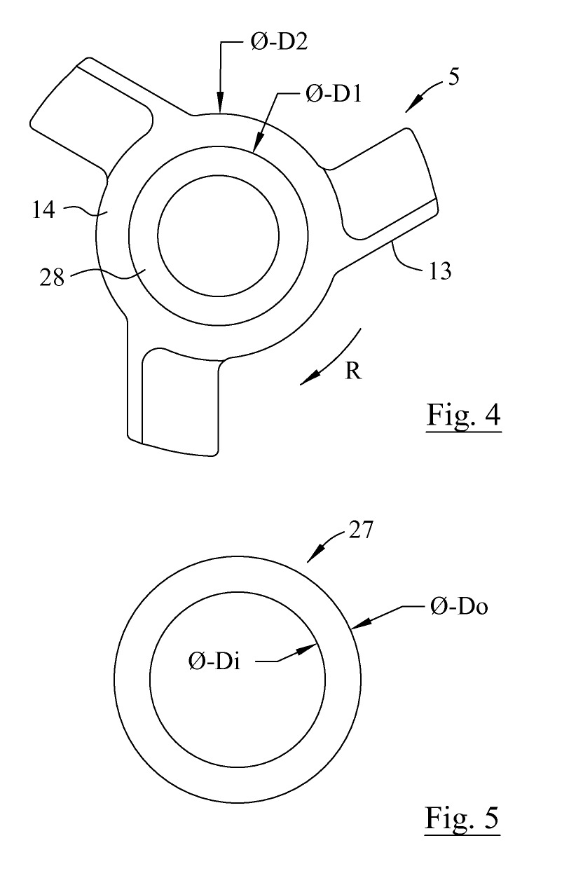

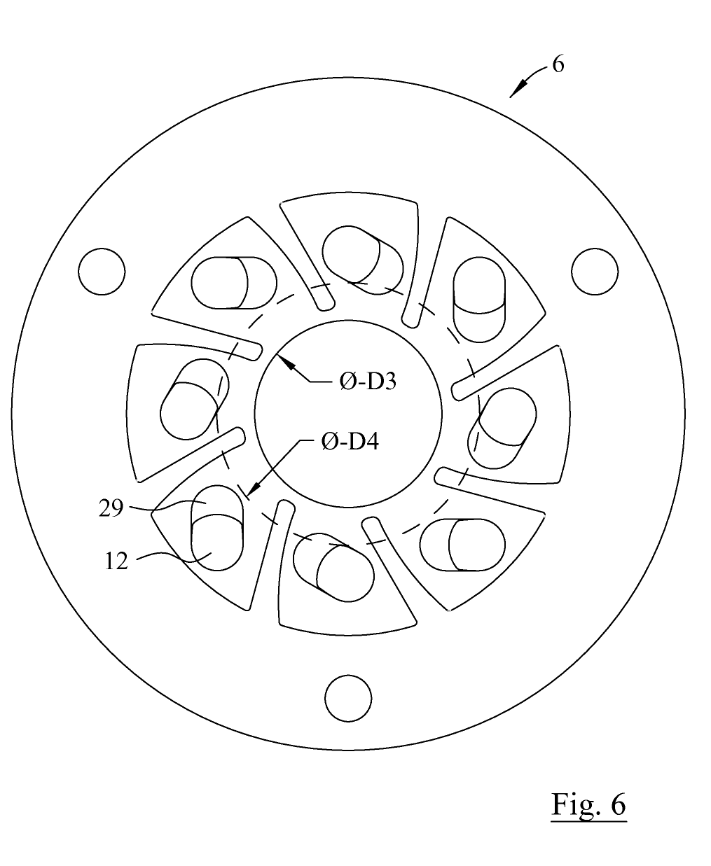

Reference is now made to FIGS. 4-6, disclosing a preferred embodiment of the cutter wheel 5 and the cutter disc 6, respectively, which are configured to interact with each other and with the shim 27. In FIG. 4 the cutter wheel 5 is disclosed from the downstream/above side, in FIG. 5 the shim 27 is disclosed from the upstream/below side and in FIG. 6 the cutter disc 6 is disclosed from the upstream/below side.

The cutter wheel 5 comprises a shaft portion 28 that has a first diameter D1 taken perpendicular to an axial center axis of the cutter wheel 5 and that is configured to interact with the central hole 24 of the cutter disc 6, i.e. the shaft portion 28 of the cutter wheel 5 is configured to be inserted into the central hole 24 of the cutter disc 6. The shaft portion 28 is preferably cylindrically shaped a distance equal to at least the thickness of the central hole 24 of the cutter disc 6. The shaft portion 28 is connected to the hub portion 14 and projects in the axial direction of the pump towards the pump chamber 2 away from the hub portion 14. When the pump is assembled the end face of the shaft portion 28 of the cutter wheel 5 shall be distanced the impeller 1, and be distanced any nut or washer securing the impeller 1 onto the drive shaft 16. The hub portion 14 of the cutter wheel 5 is wider in the radial direction of the pump than the first diameter D1 of the shaft portion 28, at the transition/interface between the hub portion 14 and the shaft portion 28. Preferably the hub portion 14 has a second diameter D2, at the transition/interface between the hub portion 14 and the shaft portion 28, wherein the second diameter D2 is bigger than the first diameter D1. In the disclosed embodiment the cutter wheel 5 comprises three wings 15 extending in the radial direction from the hub portion 14.

The cutter disc 6 comprises above mentioned central hole 24 that has a third diameter D3 taken perpendicular to an axial center axis of the cutter disc 6 and that is configured to interact with the shaft portion 28 of the cutter wheel 5. The axial center axis of the cutter disc 6 and the axial center axis of the cutter wheel 5 are the same. The third diameter D3 is less than the second diameter D2 and bigger than the first diameter D1 of the cutter wheel 5. The set of cutting holes 12 of the cutter disc 6 open in the upstream side, or suction side, of the cutter disc 6 radially outside the central hole 24. The cutting holes 12 of the cutter disc 6 are located radially outside an imaginary circle that is concentric with an axial center axis of the grinder pump and that has a fourth diameter D4. The cutter disc 6 may comprise a sloping surface or recess 29 adjacent each cutting hole 12, in order to guide the solid matter into the cutting holes 12. Some of the sloping surfaces or recesses 29 may be partly located radially inside said imaginary circle, as can be seen in FIG. 6.

An inner diameter Di of the shim 27 is greater than said first diameter D1 of the shaft portion 28 of the cutter wheel 5 and lesser than said second diameter D2 of the hub portion 14 of the cutter wheel 5. In the embodiments the shim 27 is not annular, the inner diameter Di is equal to the diameter of the biggest circle that can be inscribed by the shim 27. An outer diameter Do of the shim 27 is preferably greater than said second diameter D2 of the hub portion 14 of the cutter wheel 5. In the embodiments the shim 27 is not annular, the outer diameter Do is equal to the diameter of the smallest circle that can inscribe the shim 27. Preferably, the outer diameter Do of the shim 27 is lesser than said fourth diameter D4 of the imaginary circle of the cutter disc 6.

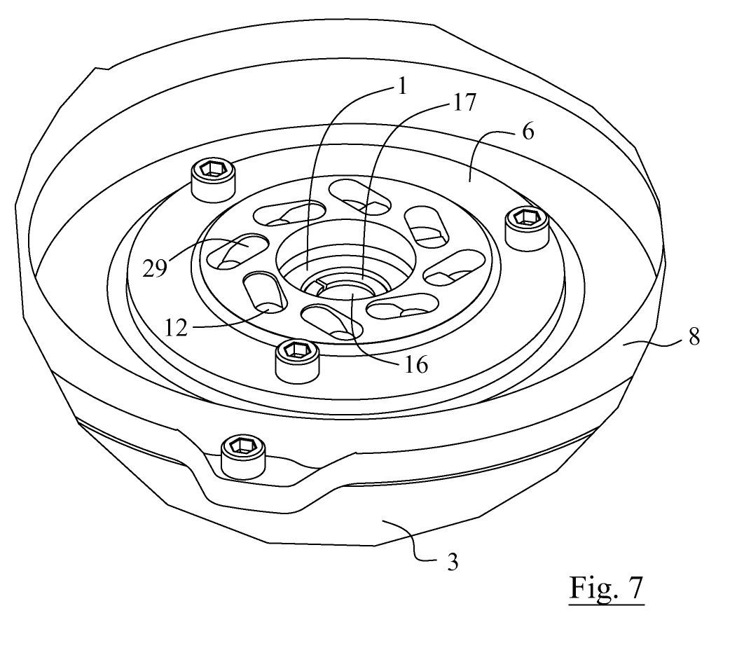

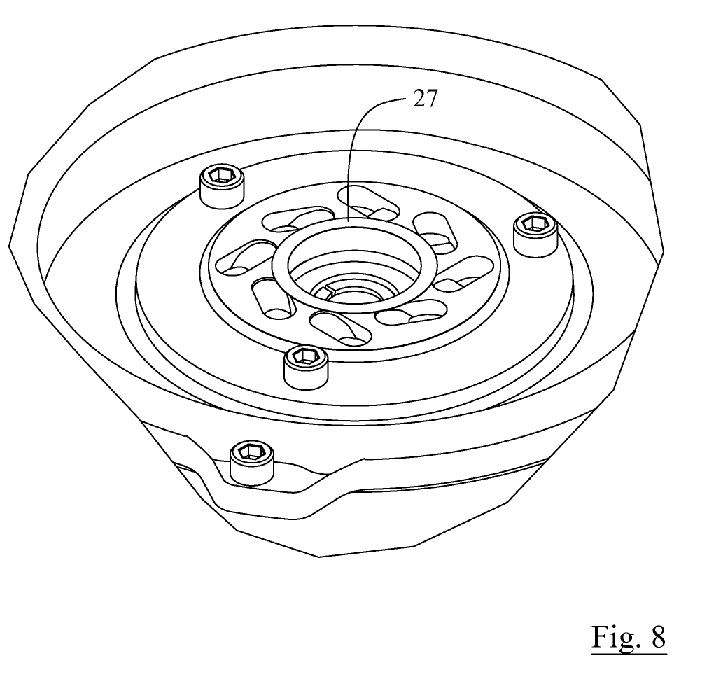

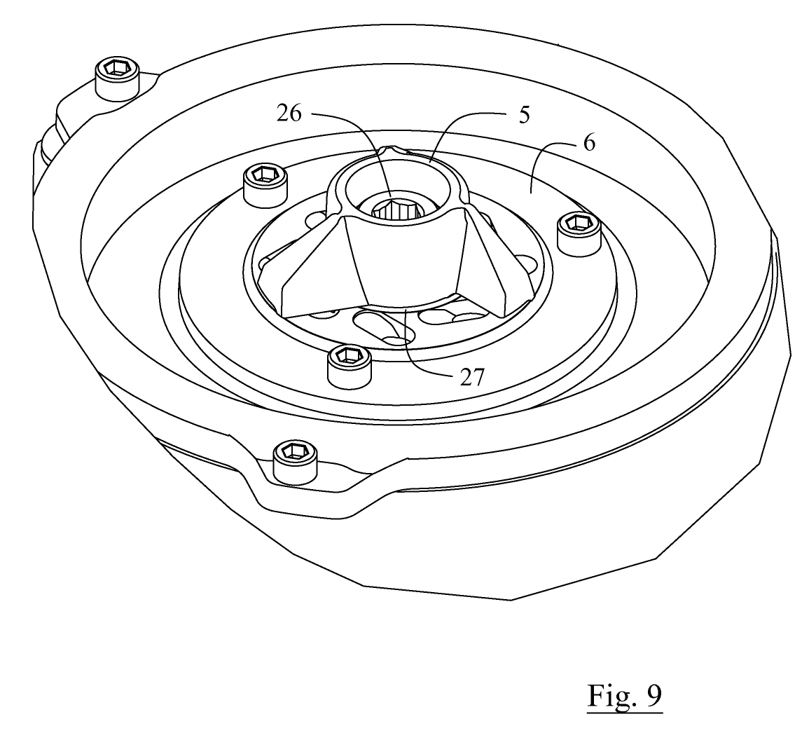

Assembly of the pump components into a state that is illustrated in FIG. 3 will be described by reference also to FIGS. 7-9. The assembly commences by having the pump housing 3 up-side-down and mounting the impeller 1 onto the lower end of the drive shaft 16, including insertion of the central bolt 20 into the bore 21 of the drive shaft 16. (The central bolt 20 is removed from FIGS. 7 and 8.) Next, the suction plate 8 is bolted to the pump housing 3, followed by bolting the cutter disc 6 to the upstream side of the suction plate 8. It shall be pointed out that the central bolt 20 may be added after the suction plate 8. See FIG. 7. Thereafter the shim 27 is located around the bolt head 22 of the central bolt 20 onto the cutter disc 6, i.e. the shim 27 is located at the shearing interface between the cutter disc 6 and the cutter head 5. See FIG. 8. Then the cutter wheel 5 is screwed onto the bolt head 22 until the cutter wheel 5 contacts the upstream surface of the shim 27, i.e. until the shim 27 is clamped between the cutter wheel 5 and the cutter disc 6. In a final step, the stop screw 26 is screwed into the central through hole 25 of the cutter wheel 5 until it abuts the opposite end face of the bolt head 22, in order to fixate the axial gap between the cutter wheel 5 and the cutter disc 6 provided by the shim 27. See FIG. 9. The stop screw 26 is preferably tightened using a predetermined tightening torque, preferably in the range 40-50 Newton meter.

A minimum and in all mounting procedures reproducible clearance between the cutter wheel 5 and the cutter disc 6 is finally established by applying the predetermined tightening torque to the stop screw 26. In result of the stop screw 26 engaging the internal thread of the cutter wheel 5 and abutting the end face of the drive shaft 16, or the end face of the drive shaft extension in terms of the bolt head 22, the stop screw 26 will exert a separating axial force that eliminates any play in the threaded engagement between the cutter wheel 5 and the bolt head 22. The cutter wheel 5 is thus forced axially away from the cutter disc 6 up to a distance less than 0.05 millimetres, i.e. enough to unclamp the shim 27.

The torque that is needed can be applied manually by means of a torque meter wrench. The size of the axial gap is determined by the thickness of the shim 27, and can be re-established at any time and is thus re-producible in maintenance and repair, and is also not depending on operator's skill. Due to the use of the shim 27 the cutter wheel 5 will be in perfect orientation in relation to the cutter disc 6, i.e. parallel, upon application of the stop screw 26 and fixation of the axial gap between the cutter wheel 5 and the cutter disc 6.

Now the grinder pump can be tested at the factory before it is shipped to a customer, and the shim 27 is configured to withstand the test run, but will later on wear/degrade and will automatically be removed at the customer during normal operation of the grinder pump.

It should be pointed out that the use of an stop screw as a locking member 26 for the cutter wheel is preferred, but the locking member may be any other member capable of applying a separating axial force on the cutter wheel and on the drive shaft in order to fixate the axial gap between the cutter wheel 5 and the cutter disc 6 provided by the shim 27. According to alternative embodiments of the locking member 26 the locking member may be constituted by a member that engages the internal thread of the cutter wheel 5 without presenting an external thread of its own. For instance the locking member may use an eccentric tightening device which is inserted into the through bore of the cutter wheel 5 in order to abut the end face of the drive shaft. Upon actuation of the eccentric tightening device, the body thereof or special means thereof may expand and engage with the internal thread of the cutter wheel, and the body or special means will expand in the axial direction as well and thereby a force will act on the end face of the drive shaft. Thereby a separating axial force is exerted by the adjusting element on the cutting wheel and on the drive shaft, and the axial gap between the cutter wheel 5 and the cutter disc 6 provided by the shim 27 is fixated.

### Feasible Modifications of the Invention

The invention is not limited only to the embodiments described above and shown in the drawings, which primarily have an illustrative and exemplifying purpose. This patent application is intended to cover all adjustments and variants of the preferred embodiments described herein, thus the present invention is defined by the wording of the appended claims and thus, the equipment may be modified in all kinds of ways within the scope of the appended claims.

For instance, it shall be pointed out that although the invention is illustrated in relation to a centrifugal pump with radial discharge, the claimed solution may obviously be used also in a pump which is designed for an axial discharge of liquid.

It shall also be pointed out that all information about/concerning terms such as above, under, upper, lower, etc., shall be interpreted/read having the equipment oriented according to the figures, having the drawings oriented such that the references can be properly read. Thus, such terms only indicates mutual relations in the shown embodiments, which relations may be changed if the inventive equipment is provided with another structure/design. Terms like radially, radial, axially, axial, etc. shall be read in relation to the pump, wherein the extension of the drive shaft define the axial direction.

It shall also be pointed out that even thus it is not explicitly stated that features from a specific embodiment may be combined with features from another embodiment, the combination shall be considered obvious, if the combination is possible.

1.-12. (canceled)

13. A grinder pump comprising:
a cutter wheel connected to and configured to be driven in rotation by an axially extending drive shaft of the grinder pump, the cutter wheel comprising a set of cutting edges, and
a cutter disc connected in a stationary manner with respect to a pump housing of the grinder pump, the cutter disc having a central hole and a set of cutting holes, the drive shaft and the cutter wheel being interconnected via said central hole of the cutter disc,
wherein the cutter wheel and the cutter disc constitute a cutter assembly configured for operative shearing action between the set of cutting edges of the cutter wheel and the set of cutting holes of the cutter disc at a shearing interface between the cutter wheel and the cutter disc,
a shim located around the drive shaft and clamped between the cutter wheel and the cutter disc, wherein a thickness of the shim is equal to or greater than 0.05 millimeters and equal to or less than 0.15 millimeters, wherein the shim is composed of either degradable paper or plastic material,
a locking member acting against the cutter wheel and the drive shaft and fixating an axial gap between the cutter wheel and the cutter disc provided by said shim,
wherein the set of cutting holes of the cutter disc are located radially outside of an imaginary circle that is concentric with an axial center axis of the grinder pump and that has a fourth diameter (D4),
wherein an outer diameter (Do) of the shim is less than said fourth diameter (D4) of the imaginary circle of the cutter disc.

14. The grinder pump according to claim 13, wherein the cutter wheel comprises:
a shaft portion having a first diameter (D1) taken perpendicular to an axial center axis of the grinder pump and that is configured to interact with the central hole of said cutter disc, and
a hub portion that is connected to the shaft portion and has a second diameter (D2), the second diameter (D2) being larger than said first diameter (D1),
wherein the set of cutting edges extends in a radial direction outwards from said hub portion.

15. The grinder pump according to claim 14, wherein the shim has an annular basic shape and wherein an inner diameter (Di) of the shim is greater than said first diameter (D1) of the shaft portion of the cutter wheel and less than said second diameter (D2) of the hub portion of the cutter wheel.

16. The grinder pump according to claim 15, wherein an outer diameter (Do) of the shim is greater than said second diameter (D2) of the hub portion of the cutter wheel.

17. The grinder pump according to claim 13, wherein the shim is composed of either biodegradable paper or plastic material.

18. The grinder pump according to claim 13, wherein a tensile strength of the plastic material of the shim is equal to or greater than 10 Newton/millimeter² and equal to or less than 50 Newton/millimeter².

19. The grinder pump according to claim 13, wherein a density of the plastic material of the shim is equal to or greater than 0.8 gram/centimeter³ and equal to or less than 1.7 gram/centimeter³.

20. The grinder pump according to claim 13, wherein a melt temperature of the plastic material of the shim is equal to or greater than 120 degrees Celsius and equal to or less than 170 degrees Celsius.

21. The grinder pump according to claim 13, wherein a hardness of the plastic material of the shim is equal to or greater than 50 Shore D and equal to or less than 70 Shore D.

22. The grinder pump according to claim 13, wherein the shim has an annular basic shape.

23. The grinder pump according to claim 13, wherein the shim is composed of Polyethylene Terephthalate (PET).

24. A method for providing an axial gap in a cutter assembly of a grinder pump in order to secure an operative shearing action at a shearing interface in said cutter assembly, wherein the method comprises the steps of:
arranging a pump housing in an upside down orientation,
connecting a cutter disc stationary with respect to the pump housing,
positioning a shim around a drive shaft of the grinder pump at the shearing interface between a cutter wheel and the cutter disc of the cutter assembly,
connecting the cutter wheel to the drive shaft via a central hole of the cutter disc, whereby said shim is clamped between the cutter wheel and the cutter disc, and
applying a locking member to act against the cutter wheel and the drive shaft and thereby fixating the axial gap between the cutter wheel and the cutter disc provided by said shim.
